(19) United States
(12) Patent Application Publication
(10) Pub. No.: US 2008/0110033 A1
(43) Pub. Date: May 15, 2008

(54) Hobby knife

(76) Inventors: Michael E. Peterson, Fairfield, CT (US); Javier Verdura, Milford, CT (US); Jonathan A. Lee, Milford, CT (US)

Correspondence Address: ALIX YALE & RISTAS LLP, 750 MAIN STREET, SUITE 1400, HARTFORD, CT, 06103, US

(21) Appl. No.: 11/598,317

(22) Filed: Nov. 13, 2006

(51) Int. Cl. B26B 3/00

(52) U.S. Cl. 30/329

(57) ABSTRACT

A hobby knife employs two threadably engaged forward and rear sections and a blade holder which mounts the knife blade for positioning generally outwardly from the front end. The forward section has a tubular shape with three angularly spaced longitudinal indentations which are traversed by a series of longitudinally spaced ribs. The forward and rear sections are substantially covered by overmold material.

### BACKGROUND

This invention relates generally to knives employed in hobby applications. More particularly, this invention relates generally to knives having an elongated handle and a knife blade extending forwardly from the handle.

### SUMMARY

Briefly stated, a preferred form of a hobby knife comprises an elongated handle having two threadably engaged forward and rear sections. A blade holder adjacent to the front end receives a knife blade for positioning generally outwardly from the front end. The forward section has a generally tubular shape with three angularly spaced longitudinal indentations. The indentations are traversed by a series of longitudinally spaced ribs. The forward section is rotatable relative to the rear section to clamp the blade holder against the received blade.

In one embodiment, each indentation has a tapered, generally triangular shape. The series of ribs comprise ribs which generally decrease in angular length as their longitudinal distance from the front end increases. The forward section defines a rounded, triangular face. The rear section has the general shape of a cigar. The exterior surface of the front and rear sections are substantially formed by an overmold material.

The front section has a tapered, central bore and the holder has a tapered exterior portion which longitudinally engages the surface of the bore to clamp opposed fingers of the holder against a received blade. The holder has a bifurcated rounded nose which extends from a threaded shaft. The rear section may have a threaded bore which is threadable with the shaft. The indentations are substantially identical and equiangularly spaced.

### BRIEF DESCRIPTION OF THE DRAWINGS

FIG. 1 is an exploded side view of a hobby knife and a protective cap;

FIG. 2 is a side elevational view of the hobby knife of FIG. 1;

FIG. 3 is a bottom plan view of the hobby knife of FIG. 2;

FIG. 4 is a top plan view of the hobby knife of FIG. 2;

FIG. 5 is an enlarged front end view of the hobby knife of FIG. 2;

FIG. 6 is an enlarged rear end view of the hobby knife of FIG. 2;

FIG. 7 is a side elevational view of the hobby knife of FIG. 1 with the cap mounted thereon;

FIG. 8 is a perspective view of the hobby knife of FIG. 1;

FIG. 9 is a perspective view of a second embodiment of the hobby knife; and

FIG. 10 is a side elevational view of the hobby knife of FIG. 9.

### DETAILED DESCRIPTION OF THE PREFERRED EMBODIMENTS

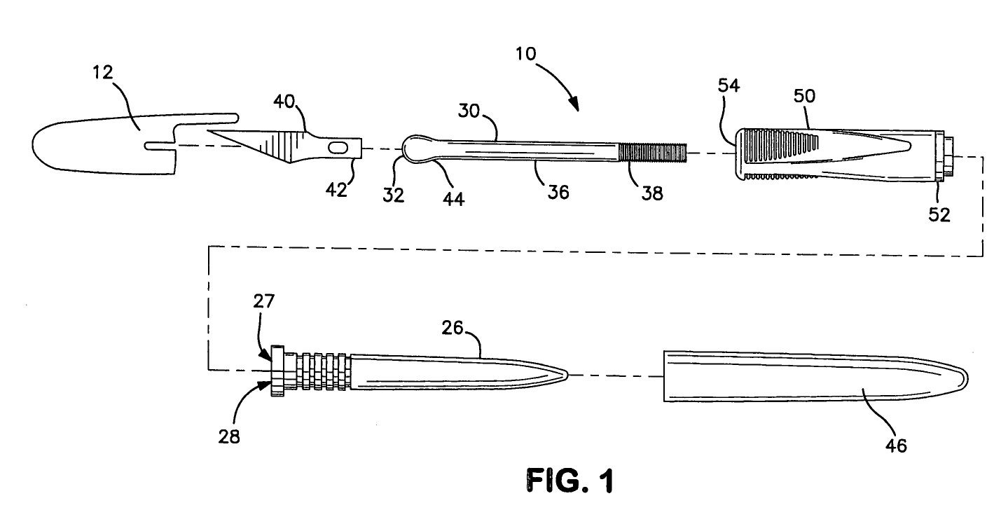

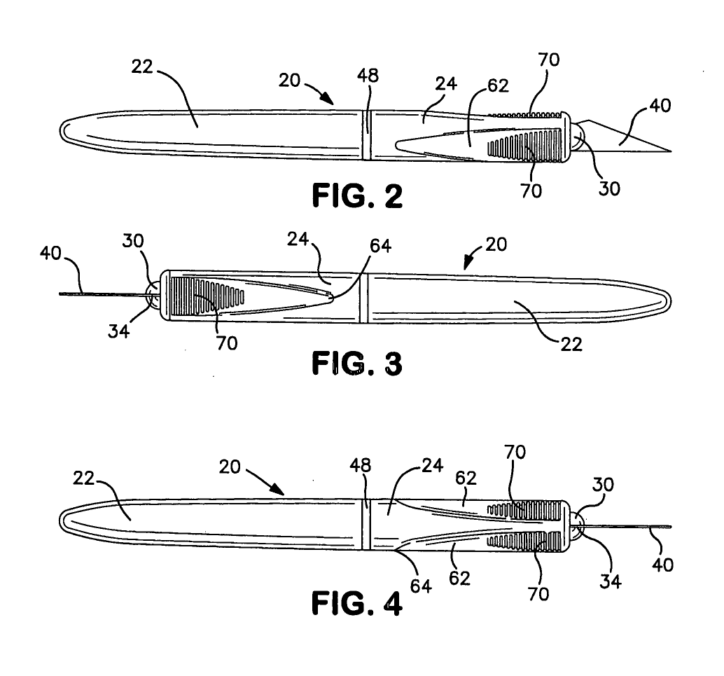

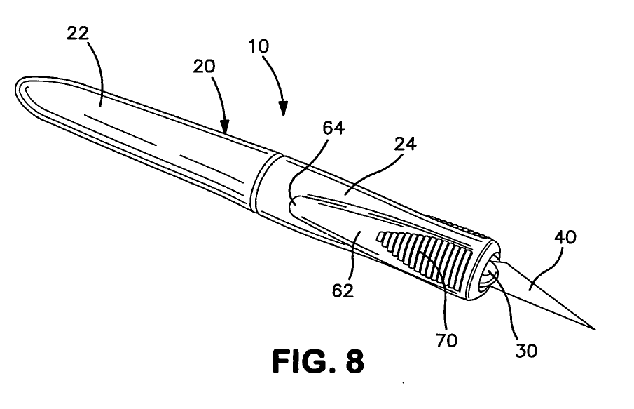

With reference to the drawings wherein like numerals represent like parts throughout the several figures, a hobby knife is generally designated by the numeral 10 in FIGS. 1-8. The hobby knife includes an elongated handle 20 which mounts a blade holder 30. The blade holder 30 receives a blade 40 which projects and extends generally forwardly from the front portion of the handle. The blade holder 30 functions to firmly hold the blade 40 in a fixed position and to release the blade to permit replacement. A protective cap 12 is dimensioned to frictionally engage the handle 20 and cover the blade 40. The cap 12 may be formed from a transparent plastic material.

The handle 20 preferably has two sections 22 and 24 which are threadably connected, as will be described below. The rear section 22 is formed from a metal tubular member 26 which has an internal bore having an internal thread 28. The top portion of the bore is enlarged to form a cavity 27. A rubber overmold 46 is formed over the tubular member 26. The tubular member 26 has a relatively small diameter to accommodate the overmold. Overmold 46 has a quasi-cigar type shape with a smooth contour and has a very soft outer feel. A preferred material composition for the overmold is a resilient polymer. Elastomers, synthetic rubbers and natural rubbers are suitable. The resilient polymer may also include other additives such as coloring agents, inhibitors, plasticizers, lubricating agents, filters, covering agents, reinforcing agents and other materials which provide striking and tactile qualities.

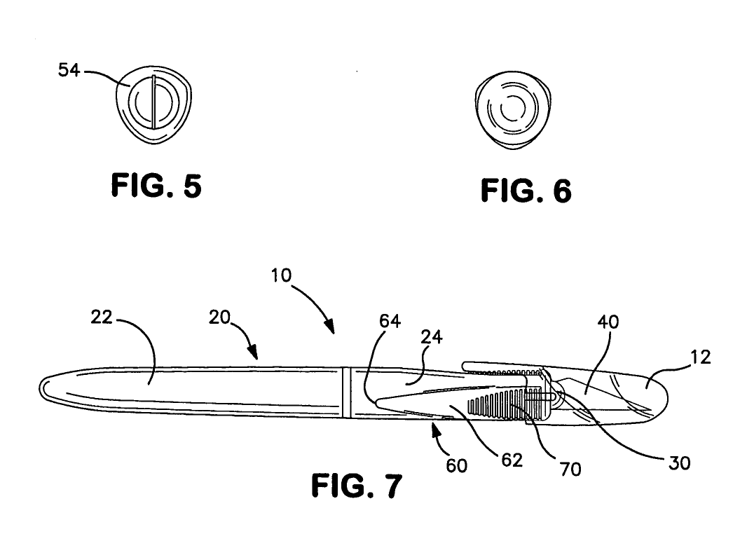

The frontal section 24 comprises an overmold 50 which forms the exterior surface of the frontal section. The overmold 50 is formed around a central metal tube. The overmold 50 is preferably manufactured from the same material as overmold 46. The tube includes a medial extension 52 which generally is received in the cavity of the rear section. With reference to FIG. 5, the front end 54 of the overmold has a quasi-rounded triangular shape with a smooth contour.

Three equiangular spaced, substantially identical, side surface configurations 60 are formed in the overmold. The configurations 60 each include a longitudinally tapered quasi-triangular indentation 62 (relative to the rounded cylindrical surface) which converges rearwardly at a rounded smooth vertex 64. The indentation 62 and, in particular, the vertex 64, smoothly blends with the generally cylindrical principal portion of the overmold. A series of ribs 70 are closely longitudinally spaced and extend arcuately at a frontal portion of the indentation. The angular extent of the ribs 70 generally decreases as the position of the ribs from the front of the overmold increases. The ribs 70 provide a very efficient gripping surface for the user of the hobby knife. The overmold composition itself functions to provide a very tactile and soft feel for the knife. The surface configurations 60 and ribs 70 facilitate gripping and manipulation of the hobby knife. It should also be appreciated that the three overmold configurations 60 each provide a stable surface to prevent the hobby knife from rolling across a surface.

The blade holder 30 includes a frontal bulbous nose 32 which is bifurcated to form a slot 34 between two clamp fingers. The holder includes a rearwardly extending shaft 36. The shaft 36 has a relatively small diameter to accommodate the overmold 50. The end of the shaft terminates with a threaded surface 38 which threads with the thread 28 in the threaded bore of the rear section. The holder portion includes a conical taper 44 adjacent the nose 32. The shaft is receivable in the tube of the front section so that the nose 32 extends generally forwardly from the front surface. The extension is received in the cavity and the shaft thread 38 engages thread 28 to connect the sections 22, 24 together.

A washer 48 may be preferably positioned between the intermediate ends of the front and rear sections to facilitate the tightening of the threaded engagement.

The blade 40 has a shank 42 which may be received in the slot 34. As the front section 24 is rotated relative to the rear section 22 for threading engagement, the conical surface 44 engages an inner cylindrical portion of the tube and forces the fingers to clamp against the received blade shank, to thereby firmly fix the blade 40.

It will be appreciated that the blade may be removed and replaced by counter-torquing the front section 24 relative to the rear section 22 so that the fingers are slightly loosened to permit disengagement of the blade from the holder. The sections are then re-torqued to tighten the blade in position at a fixed angular position relative to the central axis of the handle 20. The overmold material and the forward surface configurations cooperate to facilitate the torquing/counter-torquing of the sections.

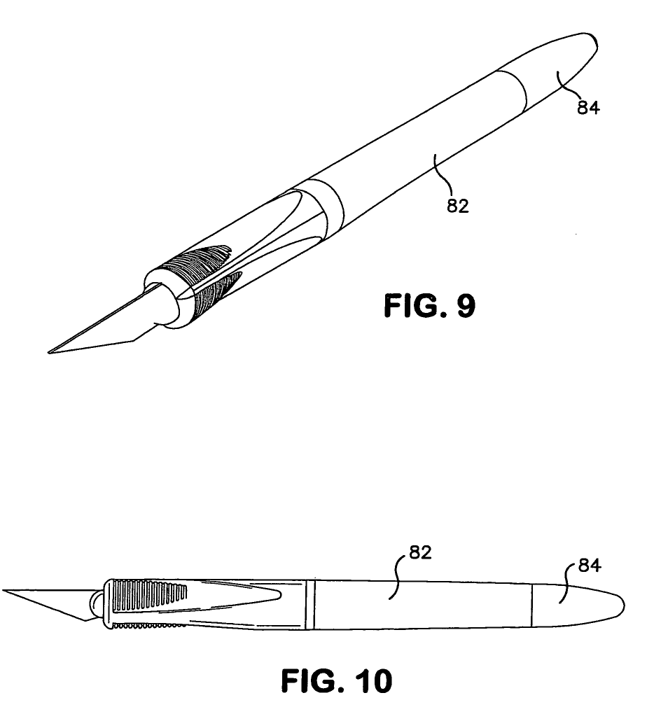

With reference to FIGS. 9 and 10, an alternative embodiment of the hobby knife with a slightly different forward section shape is illustrated. In addition, the overmold of the rear section has a longitudinally sectioned form so that in the given embodiment, several overmold portions 82 and 84 may be provided of various contrasting colors.

While preferred embodiments of the foregoing hobby knife have been set forth for purposes of illustration, the foregoing description should not be deemed a limitation of the invention herein. Accordingly, various modifications, adaptations and alternatives may be employed without departing from the scope of the appended claims.

What is claimed:

1. A hobby knife comprising:
an elongated handle having a rear end and a front end and comprising two threadably engaged forward and rear sections;
a blade holder adjacent said front end which receives a knife blade for positioning generally outwardly from said front end;
said forward section having a generally tubular shape with three angularly spaced longitudinal indentations each traversed by a series of longitudinally spaced ribs; and
said forward section being rotatable relative to said rear section to clamp said blade holder against a received blade.

2. The hobby knife of claim 1, wherein each indentation has a tapered, generally triangular shape.

3. The hobby knife of claim 1, wherein said series of ribs comprise ribs which generally decrease in angular length as their longitudinal distance from the front end increases.

4. The hobby knife of claim 1, wherein said forward section defines a rounded triangular face.

5. The hobby knife of claim 1, wherein said rear section has a generally cigar shape.

6. The hobby knife of claim 1, wherein the exterior surface of said front and rear sections are substantially covered by overmold material.

7. The hobby knife of claim 1, wherein said front section has a central bore and said holder has a pair of clamp fingers and has a tapered exterior portion which longitudinally engages the surface of said bore to clamp opposed fingers of said holder against a received blade.

8. The hobby knife of claim 1, wherein said holder has a bifurcated round nose which extends from a threaded shaft.

9. The hobby knife of claim 1, wherein said rear section has a threaded bore which is threadable with said shaft.

10. The hobby knife of claim 1, wherein said front section has a longitudinal bore which receives said blade holder.

11. The hobby knife of claim 1, wherein said indentations are substantially identical and are equiangularly spaced.

12. A hobby knife comprising:
an elongated handle having a rear end and a front end and comprising a forward section and a rear section:
a blade holder adjacent said front end which receives a knife blade for positioning generally outwardly from said front end;
said forward section having a generally tubular shape with a plurality of angularly spaced interrupted surfaces traversed by a series of longitudinally spaced ribs; and
said forward section being rotatable relative to said rear section to clamp said blade holder against a received blade.

13. The hobby knife of claim 12, wherein each surface has a tapered, generally triangular shape.

14. The hobby knife of claim 12, wherein said series of ribs comprise ribs which generally decrease in angular length as their longitudinal distance from the front end increases.

15. The hobby knife of claim 12, wherein there are three interrupted surfaces and said forward section defines a rounded triangular base.

16. The hobby knife of claim 12, wherein the exterior surface of said front and rear sections are substantially formed by overmold material.

17. A hobby knife comprising:
an elongated handle having a rear end and a front end and comprising a forward section and a rear section:
a blade holder adjacent said front end which receives a knife blade for positioning generally outwardly from said front end;
said forward section having a generally tubular shape; and
said rear section having an axially symmetric tapered configuration, said forward and rear sections having exterior surfaces which are substantially covered by overmold material.

18. The hobby knife of claim 17, wherein said forward section has three angularly spaced longitudinal portions and each portion has a tapered, generally triangular shape.

19. The hobby knife of claim 1, wherein said series of ribs comprise ribs which generally decrease in angular length as their longitudinal distance from the front end increases.

20. The hobby knife of claim 1, wherein the exterior surface of said front and rear sections are substantially formed by overmold material.
